(19) United States
(12) Patent Application Publication
(10) Pub. No.: US 2016/0180293 A1
(43) Pub. Date: Jun. 23, 2016

(54) Paid Time Off Recalculations Based on Eligibility

(71) Applicants: Jennifer Berg, Plankstadt (DE); Rehmatullah Alias Adil, Walldorf (DE); Christian Ortmann, Karlsdorf-Neuthard (DE); Christian Kirschnick, Leimen (DE); Ralf Philipp, Altlussheim (DE); Tobias Behnke, Mannheim (DE)

(72) Inventors: Jennifer Berg, Plankstadt (DE); Rehmatullah Alias Adil, Walldorf (DE); Christian Ortmann, Karlsdorf-Neuthard (DE); Christian Kirschnick, Leimen (DE); Ralf Philipp, Altlussheim (DE); Tobias Behnke, Mannheim (DE)

(21) Appl. No.: 14/577,170

(22) Filed: Dec. 19, 2014

(51) Int. Cl. G06Q 10/10

(52) U.S. Cl. CPC G06Q 10/1057

(57) ABSTRACT

In response to a change in an employee data object instance for an employee of an employer, an accrual period and an accruable period can be determined and one or more adjustment postings to a time account for the employee can be created to reflect the accrual recalculation by applying one or more accrual or business rules during the accruable period.

### TECHNICAL FIELD

The subject matter described herein relates to business software systems, in particular to systems, methods, and the like relating to determinations of employee paid time off.

### BACKGROUND

A human resources department and/or an accounting or finance department of an employer organization (e.g. a company or other entity that has employees) can handle a variety of tasks including tracking of paid time off (PTO) accrued by employees of the organization. Paid time off generically refers to any kind of time that can be taken away from employment, and can include vacation; sick leave; maternity, paternity or other family leave; medical leave, or the like. Different types of PTO can be combined into a single total of available time (e.g. days, hours, etc.) available for use by the employee or can be tracked independently by type of leave. Business software can be used by employer customers to track PTO accruals and usage by employees of the employer customer. As used herein, an employer customer is an employer organization that purchases, licenses, etc. business software from one or more software vendors.

### SUMMARY

Aspects of the current subject matter relate to detecting a change in an employee data object instance for an employee of an employer, deriving an accrual period and an accruable period, and creating one or more adjustment postings to a time account for the employee to reflect the accrual recalculation by applying one or more accrual or business rules during the accruable period. The accrual period includes an accrual period start date and an accrual period end date defining a first duration during which accrual is to be processed for the employee, and the accruable period includes an accruable period start date and an accruable period end date defining a second duration during which the employee is eligible.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a block diagram illustrating features of a business software architecture consistent with implementations of the current subject matter;

FIG. 2 shows a screenshot of an example time off configuration user interface consistent with implementations of the current subject matter;

FIG. 3 shows a screenshot of an example time account type configuration user interface consistent with implementations of the current subject matter;

FIG. 4 shows examples of accrual rule features consistent with implementations of the current subject matter;

FIG. 5 shows a screenshot of an example time account user interface consistent with implementations of the current subject matter;

FIG. 6 shows a code segment consistent with implementations of the current subject matter;

FIG. 7 shows a process flow diagram illustrating aspects of a method having one or more features consistent with implementations of the current subject matter; and

FIG. 8 shows a diagram illustrating aspects of a system showing features consistent with implementations of the current subject matter.

When practical, similar reference numbers denote similar structures, features, or elements.

### DETAILED DESCRIPTION

An eligibility status of an employee for accrual of PTO granted by the employee's employer can change due to several events or other factors. Examples of events or factors that can cause changes in an employee's eligibility for PTO accrual can include, but are not limited to, the employee going out on a maternity leave for a few months following the birth or adoption of a child (and therefore not being on active status as an employee to accrue additional PTO), an end of a waiting period for a new employee to begin accruing vacation time or other PTO after starting employment (e.g. the employee's eligibility changes form ineligible to eligible after the expiration of the waiting period), the employee undergoing a status change that is accompanied by a different accrual rate, etc.

In one illustrative example, policies of an employer can state that an employee accrues a designated amount of PTO (e.g. 30 days) on January 1, which can be used at any time during the remainder of the calendar year. Accrual of the designated amount by the employee can be based on an assumption that the employee is actively employed or otherwise available the whole year. If the employee requests a long term absence, e.g. maternity or paternity leave or a sabbatical, starting on July 1 and lasting until the end of the year, the employee's accrued PTO should be recalculated to account for time on leave that is not eligible for PTO accrual.

In another illustrative example, an employer can set a waiting period before an employee begins accruing PTO (or alternatively, one or more but not all types of PTO such as only vacation but not sick leave, or the like). If an employee starts employment on the 1st of January and has a waiting period of 6 months, he or she would be eligible for PTO accrual for 6 months during the calendar year. The employee would therefore accrue 15 days of the applicable PTO. After the employee's employment start date, a manager can decide to change the waiting period, for example if an agreement is reached with the employee to remove the waiting period completely (e.g. as an incentive award, or for some other reason). After the change, the employee's accrual of PTO for the calendar year should change automatically to the full amount of 30 days.

Consistent with implementations of the current subject matter, a human resource management system or other business software utilized by an employer organization can include functionality for individually tracking and updating a PTO accrual status for each of multiple employees of the employer organization. This tracking and updating can be performed using an instance of a data entity (e.g. a business object, a data object, or the like) defined for each employee. Using an approach consistent with the current subject matter, an employer can enable or disable automatic recalculations of employee PTO accruals by one or more business software applications based on a variety of factors or events affecting employee accrual of PTO.

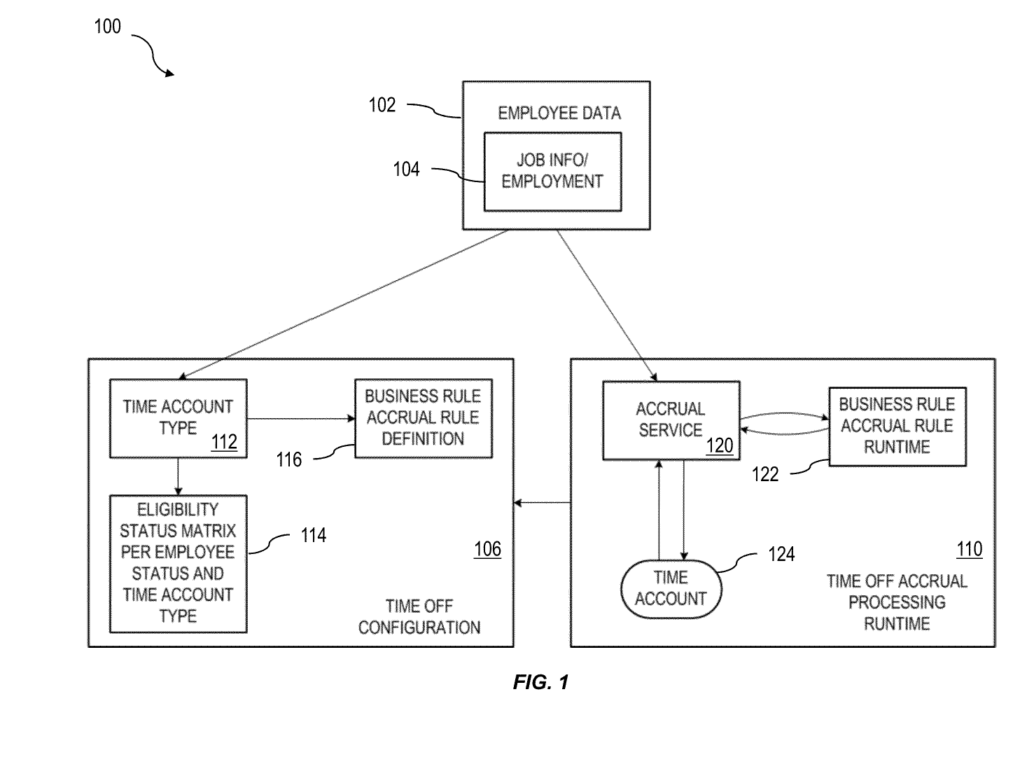

FIG. 1 shows a block diagram illustrating features of a computing framework 100 consistent with implementations of the current subject matter. An instance 102 of a business object or other data entity can be defined for each employee. This instance 102 can include data about the employee, such as for example details 104 about the employee's job, position, etc. These details 104 can include information relevant to a PTO accrual calculation, such as for example a length of the employee's employment, a baseline rate of PTO accrual for the employee, current status of the employee (e.g. on leave, active, etc.), a start date of the employee's employment, time off via a time profile, or the like. The computing framework 100 also includes a time off configuration module 106, and a time off accrual processing runtime 110, each of which can be implemented in computer circuitry, for example via execution of software by one or more programmable processors.

The time off configuration module 106 can include information about time account types 112, an eligibility status matrix per employee status and time account type 114, and business rules and accrual rule definitions 116. Time account types 112 can be assigned to an employee via a time profile.

The time off accrual processing runtime 110 can include an accrual service 120, business rule and accrual rule runtimes 122, and time accounts 124. The accrual service 120 can listen and check for (e.g. detect) relevant changes in the employee data 102. These relevant changes can be candidates for an accrual recalculation. The accrual service 120 evaluates the change candidates and reads/evaluates the configuration. Based on the configuration, an accrual period and accruable period (further defined below) is derived from the time account type 112 and the employee data 102. Definitions 116 of one or more business rules can be invoked to calculate the accrual amount. If changes to accrual are detected, the postings on the time account 124 are created and saved with the overall transaction. The time accounts 124 can contain time account postings, which can be composite child objects of type TimeAccountDetail. The booking type of accruals is either ACCRUAL or RECALCULATION.

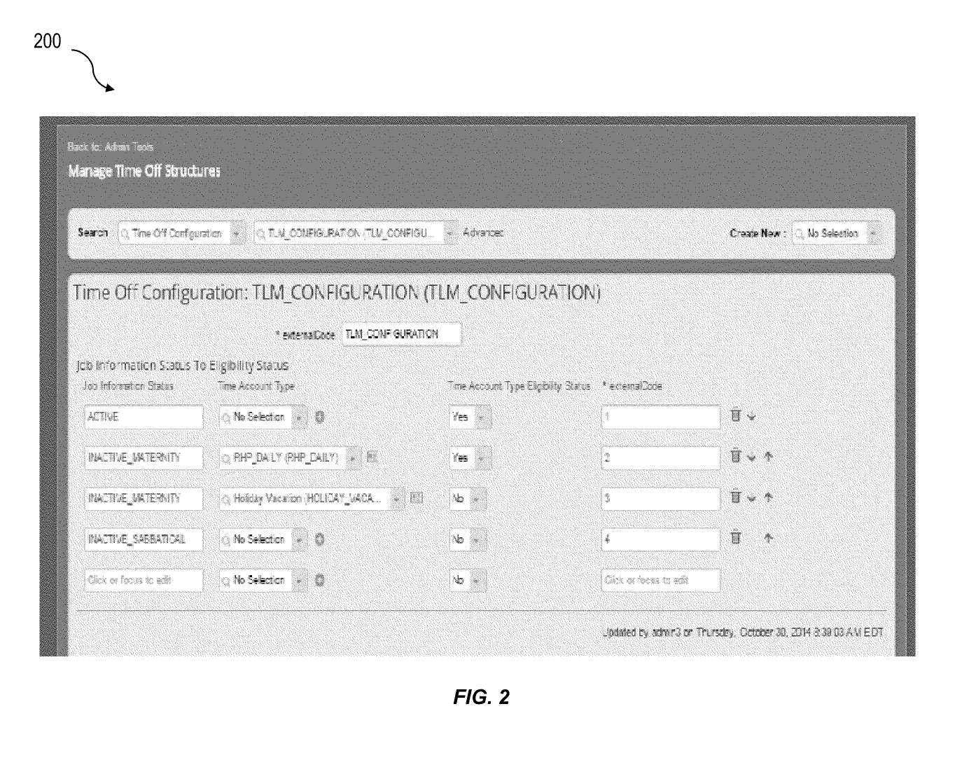

FIG. 2 shows a screenshot illustrating features of a time off configuration user interface 200 for use by an administrator or other authorized user in configuring time off calculations consistent with implementations of the current subject matter. This configuration user interface 200 can be supported by the time off configuration module 106 and can be a graphical user interface for display on one or more display devices of one or more computing systems or devices. The configuration user interface 200 can enable the administrator or other authorized user to set a definition of the eligibility status per time account type (e.g. vacation, sick leave, combined PTO, holidays, etc.). A booking type can be used to differentiate different bookings on a time account (e.g. as represented by a TimeAccountDetail entity). For example, only bookings of a booking type ACCRUAL are evaluated in order to find out whether, after re-executing a rule, the creation of a RECALCULATION plus new ACCRUAL is required. If the amount after the recalculation is identical no new postings are required. Previously available approaches generally allowed mapping to a general accrual status without specificity for time account types.

In screenshot of the configuration user interface 200 shown in FIG. 2, employees with a status of ACTIVE are set to accrue PTO for all time account types, employees with a status INACTIVE_MATERNITY accrue for a time account type RHP_DAILY but not for a time account HOLIDAY_VACATON (explicitly declared). Employees with a status of INACTIVE_SABBATICAL do not accrue for any time account types as set with “no selection” in the time account type and “no” in time account type eligibility state.

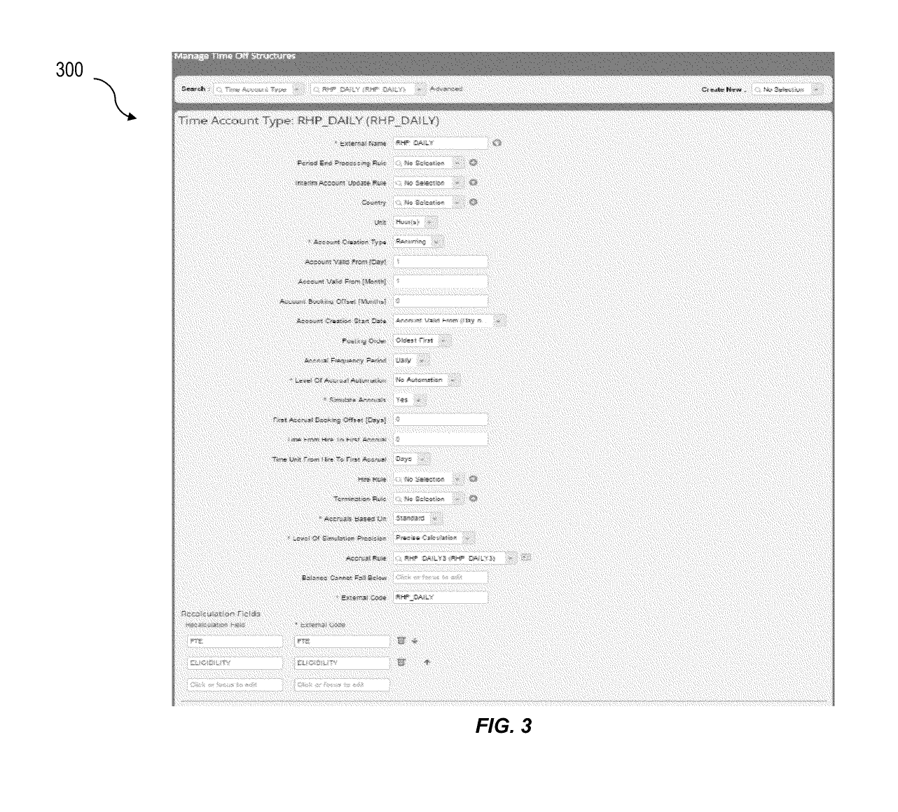

FIG. 3 shows a screenshot of a time account type configuration user interface 300, which can be supported by the time off configuration module 106 and can be a graphical user interface for display on one or more display devices of one or more computing systems or devices. The time account type configuration user interface 300 can be used by an administrator or other authorized user to define one or more change triggers that lead to accrual recalculation. In the example shown in FIG. 3, the change trigger being defined is for a change of eligibility status triggers a recalculation.

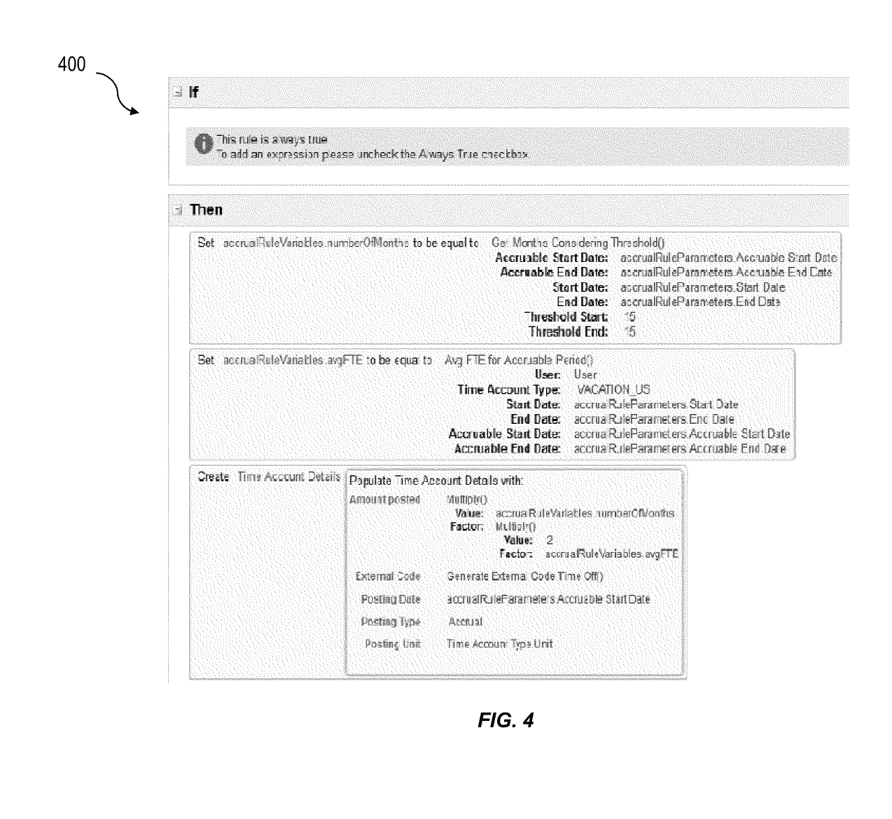

FIG. 4 shows an example of an independent definition 400 of an accrual rule. A rule can be referenced in the time account type 116 and executed during runtime 122. Time account types 124 can include accrual rules to implement the associated business logic relating to how PTO is accrued, for example, PTO can be accrued within the accruable start date and end date is typically used to determine the accrual amount.

An accrual rule can be invoked by the accrual service 120 during runtime during which the parameters are passed to a runtime artifact 122 of the design time reference 116. These parameters can include an accrual start date and an accrual end date (which can thereby define an accrual period). The accrual start date and accrual end date describe the start and end of the period (or a duration of such a period) for which a default accrual shall be processed. These dates can be determined by the time account type settings 112, which can include an accrual frequency period (e.g. yearly, semi-monthly, monthly, bi-weekly, weekly, daily etc.), a start date of the account (e.g. an employee's hire date and/or a fixed date), an account type (e.g. recurring or permanent), and the like.

The accruable start date and accruable end date define a sub-period (e.g. a duration of such a sub-period) in which the employee (for which accruals are processed) is eligible. The accruable start date cannot be earlier than the accrual start date, and the accruable end date cannot be later than the accrual end date. The employee's eligibility can be determined by one or more factors or events, such as for example eligibility status, hire date and/or termination date, assignment of a time account type to an employee time profile, etc.

In an illustrative example, an administrator can configure yearly accounts to start as of January 1. The employee has an employee time profile assigned with two time account types, such as for example vacation (which accrues if the employee's status is ACTIVE) and long service leave (which accrues if the employee's status is ACTIVE or INACTIVE_MATERNITY). Both time account types point to a rule defining that 24 days per year shall be accrued (pro-rated on a monthly level). If an employee is hired on April 1, he or she would receive 24 (days)*0.75 (year)=18 Days for both time account types. If the employee change's status to INACTIVE_MATERNITY (e.g. long term maternity leave) on October 1, a recalculation is triggered. For vacation, the accrual amount would change to 12 Days (e.g. as a result of a −18 day posting to back out the previously accrued time and a +12 posting to reflect the 6 months between April 1 and October 1 when the employee was on ACTIVE status). For long service leave, the accrual amount would not be changed.

Implementations of the current subject matter can include transactional processing features. For example, a change to the employee's job information object 104 (which describes the job and employment related data of an employee) performed by a human resources administrator, etc. can lead to a change of eligibility. As an example, if the employee starts a maternity leave or leaves active status to begin a sabbatical, the system detects the change, verifies whether it must trigger a recalculation and invokes a piece of code with triggers the rule. The job information object 104 passes the parameter values to the accrual service 120 for accrual rule execution as described above. If the result of the rule (recalculation) is different from the initial accrual amount, the system creates a negative posting (e.g. to back out previously accrues PTO) and adds a new positive posting for the period in question.

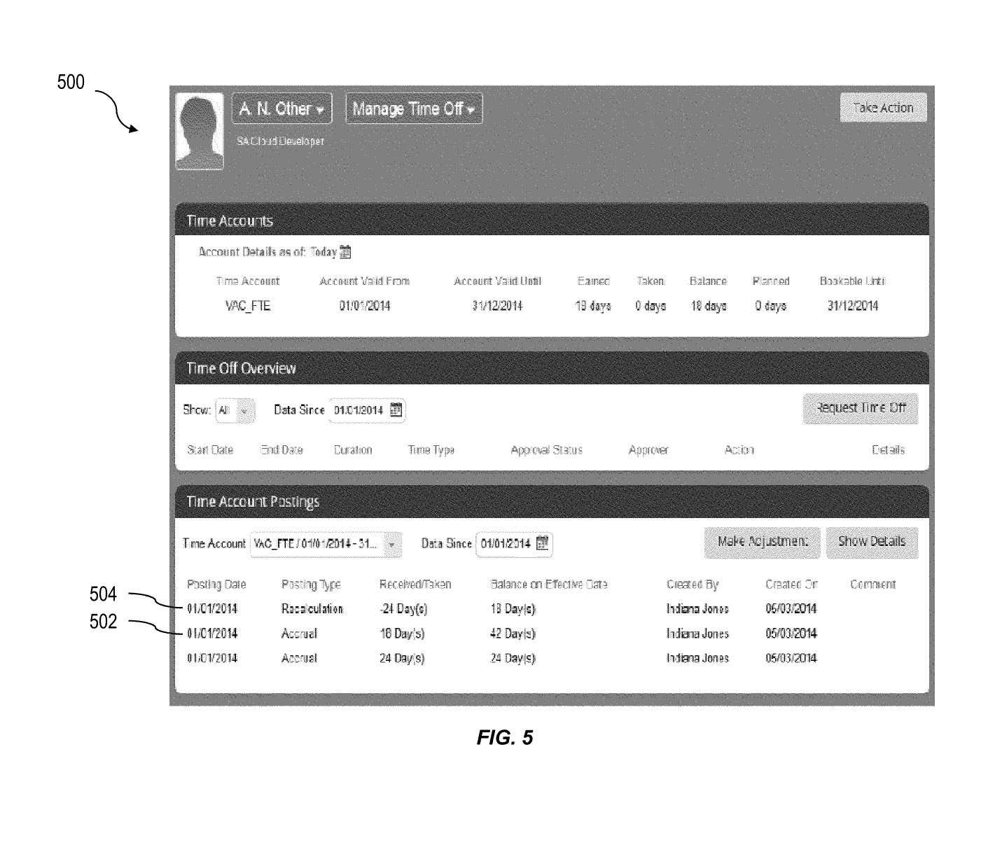

FIG. 5 shows a screenshot illustrating features of a time account user interface 500 displaying time account information for an employee and the time account postings (e.g. time account details) for the employee. The time account user interface 500 can be supported by the time off configuration module 106 and can be a graphical user interface for display on one or more display devices of one or more computing systems or devices. In the example illustrated in FIG. 5 above, the initial posting was 24 days, and a recalculation was performed to reflect that the employee was entitled to accrue only 18 days. Accordingly, a first posting 502 is created to back out 24 days and a second posting 504 is created to add in 18 days.

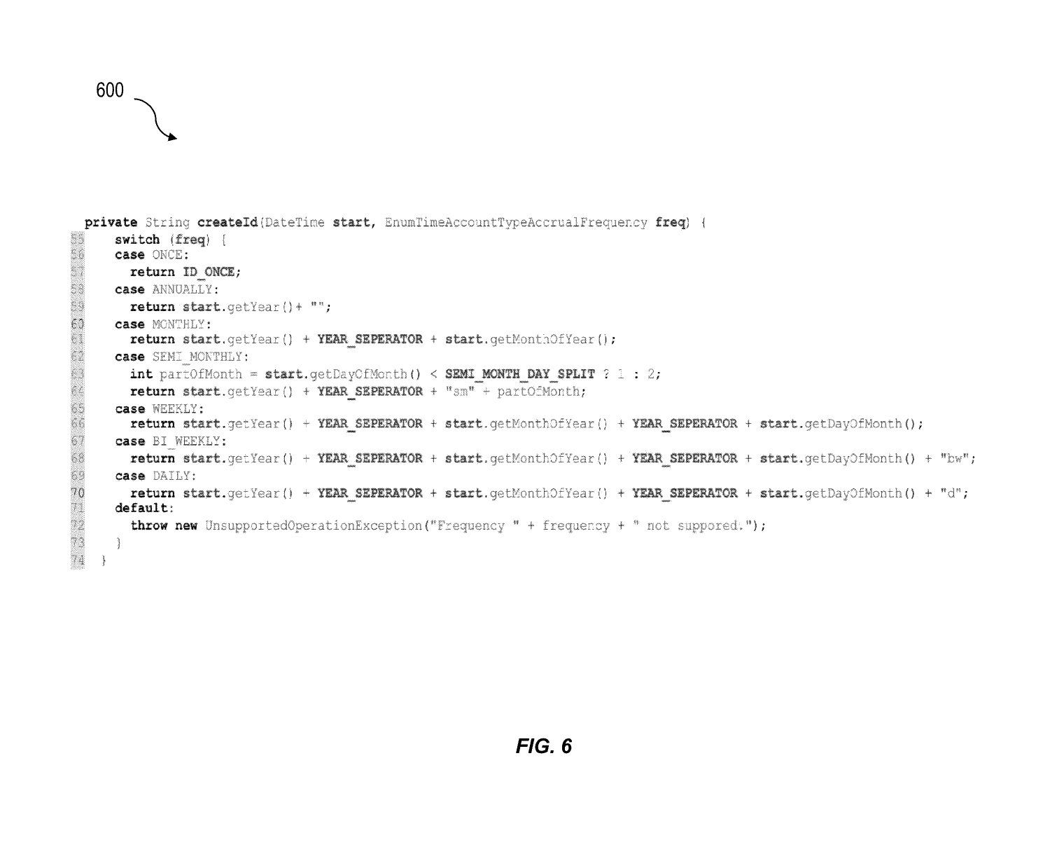

Identification of those accrual records which need to be recalculated can be performed as follows. Based on the start date of the accruable period and the accrual frequency period, a stable identifier is generated and stored with the accrual record, for example in an accrual database, which can be a database representation of the TimeAccountDetail (with booking type ACCRUAL) entity discussed above. During a recalculation, the stable identifier is read and updated (or inserted if it is missing). As an example, a valid weekly period ID is 2014-51, and a valid daily period ID is −2014-05-25. FIG. 6 shows a code segment 600 illustrating features of an example period ID generation algorithm consistent with implementations of the current subject matter. Using the stable identifier, it is possible to recalculate a period multiple times, split it up into several sub-periods with different eligibility, and make sure values are consistent. Forking and/or unifying of the sub-periods together to longer (sub-periods) or the original (maximum accrual) period can also be supported.

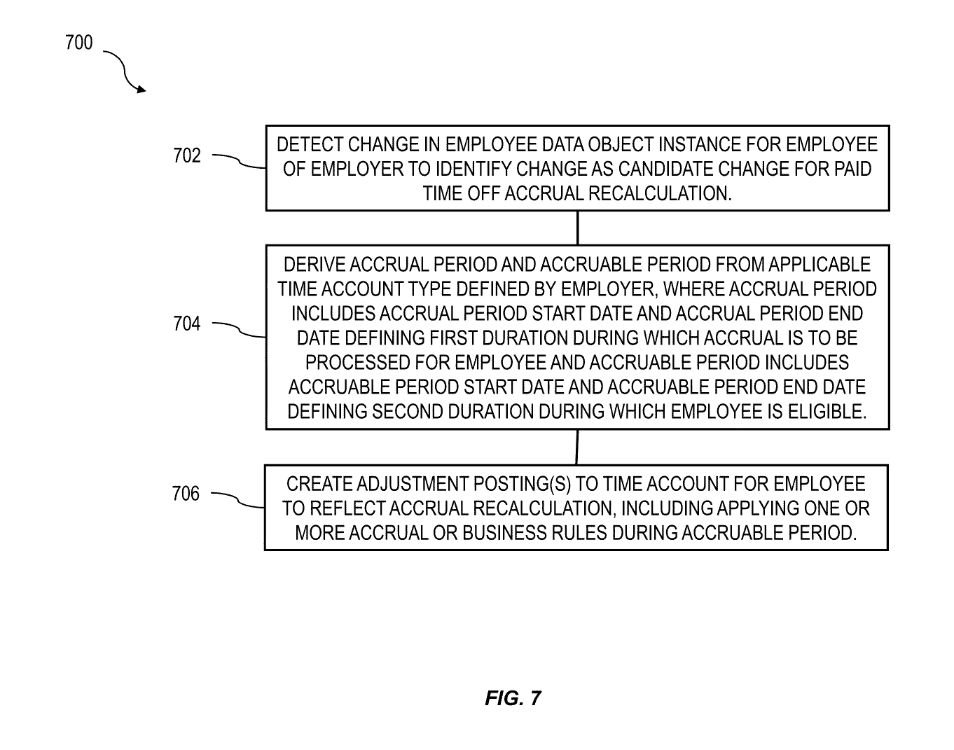

FIG. 7 shows a process flow chart 700 illustrating features of method consistent with implementations of the current subject matter. At 702, an accrual service implemented on at least one computing system detects a change in an employee data object instance for an employee of an employer. The detecting includes identifying the change as a candidate change for a paid time off accrual recalculation. The change can include changes to one or more of an eligibility status of the employee, a hire date of the employee, a termination date of the employee, and an assignment of a time account type to an employee time profile for the employee. The detecting can include generating a stable identifier based on the accrual period start date and an accrual frequency period. The stable identifier is stored with an accrual record in an accrual database.

Optionally, the accrual record identified by the stable identifier is read (i.e. the TimeAccountDetail entity with the period ID and the booking type ACCRUAL) and updated (or inserted if it is missing) during the recalculation. In this manner, accrual for an accrual period can be recalculated for multiple accruable periods reflecting multiple changes. For example, the accrual period can be split multiple times, e.g. into several accruable sub-periods with different eligibility.

At 704, an accrual period and an accruable period are derived from an applicable time account type defined by the employer. The accrual period includes an accrual period start date and an accrual period end date defining a first duration during which accrual is to be processed for the employee, and the accruable period includes an accruable period start date and an accruable period end date defining a second duration during which the employee is eligible.

At 706, one or more adjustment postings to a time account for the employee are created to reflect the accrual recalculation. The creating includes applying one or more accrual or business rules during the accruable period. The recalculation can occur over a previous recalculation. Optionally, the accrual period can be decomposed (and re-aggregated) into an arbitrary number of accruable periods (for example as long as each period has the minimum duration of one day and maximum duration of the accrual period).

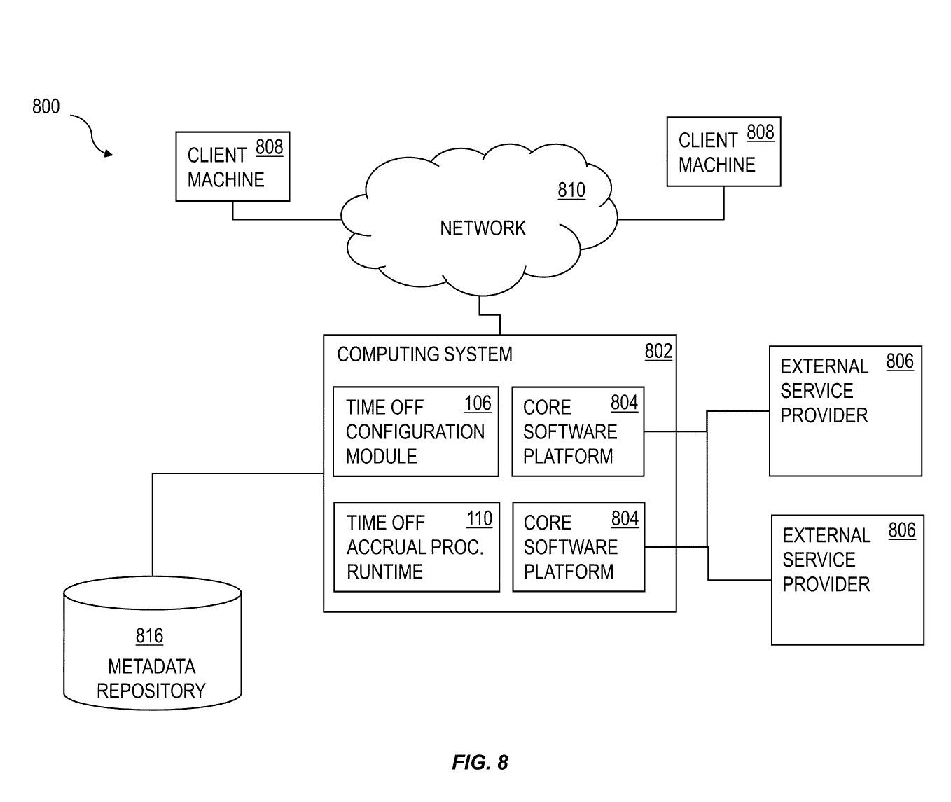

A business software architecture, which can include one or more business software applications, such as for example an enterprise resource planning system or the like, can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available business software solution to work with organization-specific business processes and functions is feasible. FIG. 8 shows a diagram of a system consistent with such an implementation. A computing system 802 can include one or more core software platform modules 804 providing one or more features of the business software system. The computing system can also aggregate or otherwise provide a gateway via which users can access functionality provided by one or more external service providers 806. Client machines 808 can access the computing system, either via a direct connection, a local terminal, or over a network 810 (e.g. a local area network, a wide area network, a wireless network, the Internet, or the like). A time off configuration module 106 and a time off accrual processing runtime 110 can be hosted on the computing system 802 or alternatively, on an external system accessible over a network connection. The time off configuration module 106 and the time off accrual processing runtime 110 can optionally include one or more discrete software and/or hardware modules that perform operations such as those described herein.

The time off configuration module 106 and the time off accrual processing runtime 110 can access one or more metadata repositories and/or other data repositories 816 (e.g. process repositories, scenarios repositories, transactional data repositories, etc.) that can store definitions of business objects or other data objects, including but not limited to the data objects deducted above, as well as data, metadata, master data, etc. relating to various business scenarios, business processes, and one or more business configurations, and/or concrete instances of data objects (e.g. business objects). In some examples, the definition can optionally be stored as a business object.

Smaller organizations can also benefit from use of business software functionality. However, such an organization may lack the necessary hardware resources, IT support, and/or consulting budget necessary to make use of a standalone business software software architecture product and can in some cases be more effectively served by a software as a service (SaaS) arrangement in which the business software system architecture is hosted on computing hardware such as servers and data repositories that are maintained remotely from the organization's location and accessed by authorized users at the organization via a thin client, such as for example a web browser, over a network.

In a software delivery configuration in which services of an business software system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a machine-readable medium storing instructions that, when executed by at least one programmable processor, cause the at least one programmable processor to perform operations comprising:
detecting, by an accrual service implemented on at least one computing system, a change in an employee data object instance for an employee of an employer, the detecting comprising identifying the change as a candidate change for a paid time off accrual recalculation;
deriving, from an applicable time account type defined by the employer, an accrual period and an accruable period, the accrual period comprising an accrual period start date and an accrual period end date defining a first duration during which accrual is to be processed for the employee, the accruable period comprising an accruable period start date and an accruable period end date defining a second duration during which the employee is eligible; and
creating one or more adjustment postings to a time account for the employee to reflect the accrual recalculation, the creating comprising applying one or more accrual or business rules during the accruable period.

2. A computer program product as in claim 1, wherein the change comprises changes to one or more of an eligibility status of the employee, a hire date of the employee, a termination date of the employee, and an assignment of a time account type to an employee time profile for the employee.

3. A computer program product as in claim 1, wherein the detecting comprises generating a stable identifier based on the accrual period start date and an accrual frequency period, the stable identifier being stored with an accrual record in an accrual database.

4. A computer program product as in claim 3, wherein the operations further comprise reading the accrual record identified by the stable identifier and updating and/or inserting the accrual record during the recalculation.

5. A computer program product as in claim 3, wherein the operations further comprise recalculating accrual for the accrual period can be recalculated for multiple accruable periods reflecting multiple changes.

6. A computer program product as in claim 3, wherein the operations further comprise decomposing the accrual period into an arbitrary number of accruable periods and re-aggregating the accrual period for the recalculating.

7. A computer-implemented method comprising:
detecting, by an accrual service implemented on at least one computing system, a change in an employee data object instance for an employee of an employer, the detecting comprising identifying the change as a candidate change for a paid time off accrual recalculation;
deriving, from an applicable time account type defined by the employer, an accrual period and an accruable period, the accrual period comprising an accrual period start date and an accrual period end date defining a first duration during which accrual is to be processed for the employee, the accruable period comprising an accruable period start date and an accruable period end date defining a second duration during which the employee is eligible; and
creating one or more adjustment postings to a time account for the employee to reflect the accrual recalculation, the creating comprising applying one or more accrual or business rules during the accruable period.

8. A computer-implemented method as in claim 7, wherein the change comprises changes to one or more of an eligibility status of the employee, a hire date of the employee, a termination date of the employee, and an assignment of a time account type to an employee time profile for the employee.

9. A computer-implemented method as in claim 7, wherein the detecting comprises generating a stable identifier based on the accrual period start date and an accrual frequency period, the stable identifier being stored with an accrual record in an accrual database.

10. A computer-implemented method as in claim 9, further comprising reading the accrual record identified by the stable identifier and updating and/or inserting the accrual record during the recalculation.

11. A computer-implemented method as in claim 9, further comprising recalculating accrual for the accrual period can be recalculated for multiple accruable periods reflecting multiple changes.

12. A computer-implemented method as in claim 9, further comprising decomposing the accrual period into an arbitrary number of accruable periods and re-aggregating the accrual period for the recalculating.

13. A system comprising:
computer hardware configured to perform operations comprising:
detecting, by an accrual service implemented on at least one computing system, a change in an employee data object instance for an employee of an employer, the detecting comprising identifying the change as a candidate change for a paid time off accrual recalculation;
deriving, from an applicable time account type defined by the employer, an accrual period and an accruable period, the accrual period comprising an accrual period start date and an accrual period end date defining a first duration during which accrual is to be processed for the employee, the accruable period comprising an accruable period start date and an accruable period end date defining a second duration during which the employee is eligible; and
creating one or more adjustment postings to a time account for the employee to reflect the accrual recalculation, the creating comprising applying one or more accrual or business rules during the accruable period.

14. A system as in claim 13, wherein the change comprises changes to one or more of an eligibility status of the employee, a hire date of the employee, a termination date of the employee, and an assignment of a time account type to an employee time profile for the employee.

15. A system as in claim 13, wherein the detecting comprises generating a stable identifier based on the accrual period start date and an accrual frequency period, the stable identifier being stored with an accrual record in an accrual database.

16. A system as in claim 15, wherein the operations further comprise reading the accrual record identified by the stable identifier and updating and/or inserting the accrual record during the recalculation.

17. A system as in claim 15, wherein the operations further comprise recalculating accrual for the accrual period can be recalculated for multiple accruable periods reflecting multiple changes.

18. A system as in claim 15, wherein the operations further comprise decomposing the accrual period into an arbitrary number of accruable periods and re-aggregating the accrual period for the recalculating.

19. A system as in claim 15, wherein the computer hardware comprises a programmable processor and a machine-readable medium storing instructions, when executed by the programmable processor, cause the at least one programmable processor to perform at least some of the operations.
